(19) United States
(12) Patent Application Publication
(10) Pub. No.: US 2024/0257176 A1
(43) Pub. Date: Aug. 1, 2024

(54) Techniques for Presenting a Plurality of Content Items in a Reward Impression

(71) Applicant: Google LLC, Mountain View, CA (US)

(72) Inventors: Samsudin Kamis, Santa Clara, CA (US); Chitra Kannan Kashyap, Los Altos, CA (US); William Frazier Pierpont Grose, Los Angeles, CA (US); Alex Pan, Mountain View, CA (US); Yi Yang, Los Angeles, CA (US); Charlotte Yao, Mountain View, CA (US); Chunlei Zhu, Shanghai (CN); Zaiyue Xue, Shanghai (CN); Benjamin Schaeffer, Mountain View, CA (US)

(21) Appl. No.: 18/162,279

(22) Filed: Jan. 31, 2023

(51) Int. Cl. G06Q 30/0242; G06Q 30/0235

(52) U.S. Cl. CPC G06Q 30/0244; G06Q 30/0235; G06Q 30/0246

(57) ABSTRACT

The present disclosure provides techniques for presenting a reward impression. A computing system can receive, from a client device, a request to view the reward impression having a first time slot and a second time slot. The computing system can calculate a first conversion rate associated with a first content item being presented in the first time slot and a second conversion rate associated with a second content item being presented in the second time slot. The computing system can select, using the one or more machine-learned models based on the first conversion rate and the second conversion rate, the first content item and the second content item from a plurality of content items. The computing system can cause the presentation of the first content item in the first time slot and the second content item in the second time slot of the reward impression.

### FIELD

The present disclosure relates generally to machine learning techniques for presenting content items. More particularly, the present disclosure relates to systems and methods for selection and optimization of a plurality of content items to be presented in a reward impression.

### BACKGROUND

Computing devices, including mobile devices such as smartphones and tablets, execute applications that may include functionality for presenting content (e.g., offers or advertisements) delivered to the devices via a network. In some instances, an application may provide a reward or benefit in exchange for engaging with presented content.

One technique to increase user engagement is through the use of a reward impression. The reward interaction can be a continuous time slot. The reward impression can include an action or operational change by the application taken with respect to a user. However, identifying an ideal content item to be presented to a user is a challenging task. The application may then provide a reward in response to presenting the reward interaction.

### SUMMARY

Aspects and advantages of embodiments of the present disclosure will be set forth in part in the following description, or can be learned from the description, or can be learned through practice of the embodiments.

One example aspect of the present disclosure is directed to a computing system. The computing system can present a reward impression in a computer application. The computing system can include one or more processors, one or more non-transitory computer-readable media that collectively store: one or more machine-learned models configured to determine a time slot to present a content item in the reward impression; and instructions that, when executed by the one or more processors, cause the computing system to perform operations. The operations can include receiving, from a client device, a request to view the reward impression. The reward impression can have a first time slot and a second time slot. Additionally, the operations can include accessing, from a content database, a plurality of content items. The plurality of content items having a first content item and a second content item. Moreover, the operations can include calculating a first conversion rate associated with the first content item being presented in the first time slot, and calculating a second conversion rate associated with the second content item being presented in the second time slot. Furthermore, the operations can include selecting, using the one or more machine-learned models based on the first conversion rate and the second conversion rate, the first content item to be presented in the first time slot and the second content item to be presented in the second time slot. Subsequently, in response to the selection, the operations can include the presentation of the first content item in the first time slot of the reward impression and the presentation of the second content item in the second time slot of the reward impression.

In some instances, the operations can include updating the content database by associating the first content item with the first conversion rate and the subsequent conversion rate. In some examples, the subsequent conversion rate can be less than the first conversion rate.

In some instances, the first conversion rate can be calculated by the one or more machine-learned model based on a cost per impression rate for presenting the first content item in the first time slot of the reward impression.

In some instances, the first conversion rate is calculated by the one or more machine-learned model based on an objective (e.g., preference) from a developer (e.g., publisher). The preference can be associated with a type of content being presented in the first time slot of the reward impression.

In some instances, the first content item has a first duration and the second content item has a second duration. Additionally, the operations can further include selecting, based on the first duration, the first content item from the plurality of content items to be presented in the first time slot of the reward impression. Moreover, the operations can further include selecting, based on the second duration, the second content item from the plurality of content items to be presented in the second time slot of the reward impression.

In some instances, the operations can include calculating a total duration value by adding the first duration and the second duration. Additionally, the operations can include determining that a total duration value is greater than a threshold time value associated with the reward impression. In response to the total duration value being greater than the threshold time value, the operations can include modifying the first content item, using the one or more machine-learned model, by removing a section of the first content item.

In some instances, the first content item can include a first video and a first end card, wherein the first end card is presented after the first video with a link to install a first mobile application on the client device. Additionally, the second content item can include a second video and a second end card, wherein the second end card is presented in response to a swipe gesture to the first end card.

In some instances, the second content item is further determined based on the first content item. In some instances, the first content item is presented on a mobile application that is developed by a developer.

Another example aspect of the present disclosure is directed to a computer-implemented method. The computer-implemented method can include receiving, from a client device, a request to view the reward impression, the reward impression having a first time slot and a second time slot. The method can further include accessing, from a content database, a plurality of content items, the plurality of content items having a first content item and a second content item. Additionally, the method can include calculating a first conversion rate associated with the first content item being presented in the first time slot and a second conversion rate associated with the second content item being presented in the second time slot. Moreover, the method can include selecting, using the one or more machine-learned models based on the first conversion rate and the second conversion rate, the first content item and the second content item from the plurality of content items. Furthermore, in response to the selection of the first content item and the second content item, the method can include the presentation of the first content item in the first time slot of the reward impression and the presentation of the second content item in the second time slot of the reward impression.

Another example aspect of the present disclosure is directed to one or more non-transitory computer-readable media that store instructions that, when executed by one or more computing devices, cause the one or more computing devices to perform operations. The operations can include receiving, from a client device, a request to view the reward impression. The reward impression can have a first time slot and a second time slot. The operations can further include accessing, from a content database, a plurality of content items. The plurality of content items can have a first content item and a second content item. The operations can include calculating a first conversion rate associated with the first content item being presented in the first time slot and a second conversion rate associated with the second content item being presented in the second time slot. The operations can further include selecting, using the one or more machine-learned models based on the first conversion rate and the second conversion rate, the first content item and the second content item from the plurality of content items. In response to the selection of the first content item and the second content item, the operations can include causing the presentation of the first content item in the first time slot of the reward impression and the presentation of the second content item in the second time slot of the reward impression.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs content item selection for various time slots according to example embodiments of the present disclosure.

FIG. 1B depicts a block diagram of an example computing device that performs impression optimization according to example embodiments of the present disclosure.

FIG. 1C depicts a block diagram of an example computing device that performs impression optimization according to example embodiments of the present disclosure.

FIG. 2 depicts a flow chart diagram of an example method to present a reward impression according to example embodiments of the present disclosure.

FIG. 3 depicts a flow chart diagram of an example method to calculate conversion rates for a content item to be presented in different time slots of a reward impression according to example embodiments of the present disclosure.

FIG. 4 depicts a flow chart diagram of an example method to truncate a content item prior to presenting the content item in a time slot of a reward impression according to example embodiments of the present disclosure.

FIG. 5 depicts a block diagram of an example graphical user interface of a reward impression being presented on a client device according to example embodiments of the present disclosure.

FIG. 6 depicts a block diagram of another example graphical user interface of a reward impression being presented on a client device according to example embodiments of the present disclosure.

Reference numerals that are repeated across plural figures are intended to identify the same features in various implementations.

### DETAILED DESCRIPTION

### Overview

A reward impression can be an event in a computer application (e.g., gaming application), where users are presented with an option to opt-in and watch a content item (e.g., video) in return for a reward. The reward impression may only be served after a user affirmatively opts to view a reward impression. In some instances, a user of a mobile gaming application can receive a reward (e.g., an extra life in the gaming application) if the user interacts with a content item (e.g., watches a video, plays a limited version of a mobile game). In some instances, the content item can be a video or a playable interaction (e.g., a HTML file) where the user can interact with the mobile application (e.g., play the mobile game).

A computer application executing on a client device may occasionally present third-party media to a user of the client device and wait for the user to engage with the third-party interactive media. If the user engages with the media, the application may reward the user by providing in-game incentives. As an illustrative example, a user can play a racing game and the car crashes. At this point, the user can either start over or the developer (e.g., game developer) can give the user an option to view a reward impression to continue with the racing game. The reward impression, as determined by the models, can include a plurality of selected content items presented in various time slots of the reward impression. For example, the models can determine which content items and the number of content items to present to the user at the different reward impressions. Moreover, the model can determine which time slots to present each of the selected content items during the reward impression.

In some instances, a plurality of videos can be shown for a specific amount of time (e.g., 30 seconds) in the reward impression. Additionally, at the end of the videos, an end card can be presented to the user to install a mobile application associated with one of the videos. The user can interact with the end card to install the mobile application associated with the video. For example, the user can click on a button presented on the end card or perform a swipe gesture to automatically install the mobile application.

In conventional systems, the reward impression typically only presents one video (e.g., 30 second video) to the user. In contrast, according to embodiments of the present invention, the system can merge and present a plurality of content items (e.g., video, playable interactions) during the reward impression. The plurality of content items can be shorter length videos (e.g., 6 seconds, 15 seconds, 20 seconds) that are merged (e.g., combined, joined) together by the system. In some instances, the system can truncate (e.g., remove a section) one or more of the content items (e.g., video) so that the plurality of the content items can be presented during the allocated time of the reward impression. For example, if two videos are both 16 seconds and the allocated time for the reward impression is 30 seconds, then the system can truncate from each video by one second. Alternatively, the system can truncate two seconds from one of the videos in order for both videos to fit within the allocated 30 second time.

In some instances, the plurality of content items can be merged together by the system prior to transmitting the content items to the mobile device in order to reduce network latency and reduce processing resources requirements at the mobile device. Additionally, the reward impression can include a plurality of end cards associated with each content item.

According to some embodiments, the system includes one or more machine-learned models to predict user engagement during presentation of the third-party media and calculate a predicted conversion rate (e.g., a likelihood that the user engaged with the presented media). The models can include a prediction mechanism that predicts a predicted conversion value (e.g., clickthrough rate (CTR)) for any format or any creative. The CTR can be the number of clicks that a content item receives divided by the number of times the content item is shown (e.g., clicks÷impressions=CTR). For example, if a content item had 5 clicks and 100 impressions, then the CTR would be 5%. The model can determine the first content item and the second content item based on the predicted conversion rate for an impression at a specific time slot, and a bid value for the conversion of the impression at the specific timeslot.

In some instances, the reward impression can have a plurality of time slots (e.g., first time slot, second time slot). The machine-learned models can select, based on the conversion rate for the first content item, a first content item from a plurality of content items to be presented in the first time slot of the reward impression. Additionally, the machine-learned models can select, based on the conversion rate of the second content item, a second content item from a plurality of content items to be presented in the second time slot of the reward impression.

In some instances, the models can include position normalization mechanisms, where the models determine the predicted conversion rate of a content item in relation to the time slot that the content item is served. For example, there can be a plurality (e.g., two) positions available in a reward impression (e.g., pod). When there are two positions in the reward impression, then there is a first time slot and a second time slot in the reward impression. For example, the reward impression can include two videos, and the system can transition from a first video in the first time slot to a second video in the second time slot. The content provider associated with the content item can bid a first bid value for the first time slot and a second bit value for the second time slot. The first time slot can be more valuable than the second time slot because it is shown first, so the first bid value can be usually greater than the second bid value. Additionally, the predicted conversion rate for the first time slot can be different (e.g., higher) than the predicted conversion rate for the second time slot.

In some instances, the reward impression can include a timer indicating the amount of time left in the reward impression. For example, the timer can be located on a specific location (e.g., top right of the graphical user interface) of the reward impression and have an amount of time (e.g., 30 seconds) that is counted down until the reward impression is finished. At the end of the reward impression, the system can present end cards. The system can present an end card for each content item presented in the reward impression. For example, a user can swipe to look at the different end cards. Additionally, a user can interact with the end card to perform an action. For example, the reward impression can include a first content item associated with a mobile gaming application, and the user can click a button presented on the end card to install the mobile gaming application.

In some instances, the system can truncate a content item (e.g., video). For example, the system can receive a video, and subsequently generate a shorter video. The system, using the machine-learned models, can generate a shorter video by removing the trivial aspects of the received video. For example, the machine-learned models can determine the relevant aspects of the received video and generate a shorter video based on the determination.

In some implementations, the selected reward impressions can be automatically performed, thereby greatly reducing the workload for application developers while also reducing user churn or otherwise improving other measures of user engagement.

More particularly, aspects of the present disclosure are directed to reducing user churn out of a computer application and/or addressing other objectives including custom developer-specified objectives (e.g., specific content type to present in the reward impression). As used herein, the term “application” broadly includes various different computer programs, software, and/or systems. One example application is a mobile application such as, for example, a text messaging application installed on a mobile device (e.g., smartphone). A developer or other individual or organization involved with providing the mobile application may seek to maximize the number of entities (e.g., daily users) of the mobile application or, stated differently, may seek to minimize user churn out of the mobile application. Another example of a computer application is a website. For example, a website owner may seek to maximize the number of entities that “visit” or otherwise interact with her website on a periodic basis (e.g., daily, weekly). Another example of a computer application is a computer game (e.g., a mobile game, a game for a dedicated gaming console, a massively multiplayer online game, a browser game, a game embedded in a social media platform, an augmented or virtual reality game). Another example application may be a traditional computer application executed on a desktop, laptop, tablet, or the like.

According to aspects of the present disclosure, a computing system can interact with the computer application to prevent user churn out of the application and/or in furtherance of other objectives such as increasing an allocation of user resources (e.g., time, currency such as virtual currency, computing resources, etc.) into the application. To fulfill these objectives, the computing system can operate to automatically intervene in the computer application.

In some implementations, some or all of the available reward impressions that the system can perform can be specified by the developer or other party associated with the application. As examples, for an example gaming application, the developer might specify a set of reward impressions which can include: give free in-game object (e.g., battle ax, enhanced player attribute); make game level easier to pass for a time period; don't show any external content; or show twice as much external content, or other reward impressions. Thus, the developer can provide specific input that controls which reward impressions can be performed by the computing system. The developer can also specify various rules and/or relationships that control characteristics of the system's use of the impression such as how frequently an impression can be performed, how many reward impressions can be performed for a given user, which reward impressions can or cannot be performed at the same time, a maximum number of reward impressions per time period, and/or similar information. Moreover, the developer can provide specific content types (e.g., installation of mobile application, link to a third-party website, link to a product) to be presented in the reward impression.

Thus, in some implementations, the computing system can include a user interface and backend that allows developers to provide rules associated with a reward impression. In one example, the user interface can include impression name, remote configuration parameters to enable/disable the impression, valid values, acceptable frequency, and/or an identification of objectives (e.g., revenue, retention, custom).

In some implementations, the computing system, using machine-learned models, can calculate a conversion rate for a content item for a specific time slot in the reward impression. Additionally, the system can input the content items with their different conversion rates for each specific time slot into a machine-learned model to select which content items to present in the various time slots of the reward impression. The machine-learned model can provide a respective conversion rate for each content item that is determined based at least in part on the duration of each content item.

In some implementations, the machine-learned model can be trained and operated according to a reinforcement learning scheme. For example, the machine-learned model can be or include an impression agent in a reinforcement learning scheme. For example, the impression agent can apply a policy to select certain actions (e.g., present a content item in a specific time slot) based on a current state and can receive a respective reward associated with an outcome of each action. The computing system can optimize the machine-learned model based on the respective rewards to improve the policy of the impression agent. For example, the machine-learned model can compute a respective probability that each of the plurality of available content items will improve the conversion rate. In some implementations, in addition to the measure of the conversion rate, an objective value is further determined based at least in part on an allocation of resources by the user within the computer application. For example, the machine-learned model can compute a respective probability that each of the plurality of available content items will enable users to allocate resources in the computer application based on the respective conversion rate associated with users.

More particularly, in some implementations, the impression agent can receive the current conversion rate for a particular user and can treat such conversion rate as the state. Based on the state, the impression can select one or more actions to perform, where actions describe how one or more content items are applied to users. The actions can be single actions or strings of actions. For example, a first action can indicate that a first content item is presented in a first time slot of a reward impression, a second action can indicate that a second content item is presented in a second time slot of the reward impression, and a third action can indicate that a third content item is presented in a third time slot of the reward impression. Based on the outcome of the actions, the impression agent can receive a reward. For example, the reward can be determined using the objective function, where the objective function measures user churn or other characteristics of user engagement. The computing system can update or modify the policy of the impression agent based on the received reward, thereby leading to an improved policy that enables the model to select a content item for a specific time slot in the reward impression.

In some implementations, in addition or alternatively to the use of reinforcement learning, the machine-learned model can be trained using supervised learning techniques. For instance, the computing system can train the model based on training data. The training data can include a set of user histories (e.g., user click history, predicted conversion rate) and reward impressions that were selected based on such user histories. The training data can include a respective ground-truth label for each pair of conversion rate/impression that describes a known outcome that occurred after the impression. In some implementations, the computing system can train the impression selection model using various training or learning techniques, such as, for example, backwards propagation of errors. In some implementations, performing backwards propagation of errors can include performing truncated backpropagation through time.

As described above, not all content items that are defined in the system can be used at every reward impression. For example, developer-defined rules can prevent recurring usage of particular content items. As such, in some implementations, the computing system can identify which of a plurality of defined content items are available at a particular time. The plurality of available content items can be a subset of the plurality of defined content items that satisfy one or more developer-supplied criteria and/or other rules at a time of selection. The machine-learned model or the system that executes upon its predictions can be configured to select only available content items for use.

In some implementations, the machine-learned model can be located within a server computing device that serves the computer application. For instance, the server computing system can include the model and provide the selected content items for a specific time slot to the computer application that can be installed on a user computing device according to a client-server architecture.

In other implementations, the machine-learned model can be located within the computer application on a user computing device. For instance, the user computing device can include the computer application having the model to select the content items for a specific time slot.

In yet other implementations, the machine-learned model can be located on the user computing device with the computer application but can be external to the application. For example, the machine-learned model can serve multiple different applications on the user computing device according to a client-server architecture.

In some implementations, the computing system can send user-activity-events from a computing device that executes the application (e.g., a user device such as a mobile device) to a server computing system (e.g., a production server). The server computing system can receive events and collate the events and can then store those events for each user. The computing system can include a machine learning system that trains the machine-learned model based on all the events. The computing system can take the trained machine-learned model and can perform conversion rate calculations for the plurality of content items being presented at various time slots, and can then store those calculations. The computing system can fetch stored conversion rates when the computer application needs to know which content item to present in a reward impression. The computing system can include a feedback system that can record when each content item was presented and record the user activity associated with the presentation of a content item. The user activity can be inputted to the training of the models to update one or more parameters of the model used for calculating the conversion rate. The computing system can also include a user interface and backend that allows third-party devices to provide the plurality of content items.

Thus, the present disclosure provides systems and methods that optimize the presentation of content items in various time slots to improve user experience in a computer application. The provided system removes the need for developers to explicitly take action on predictions regarding churn. Instead, content providers can provide content items, and the system will learn which of these content items should be presented during which time slot to maximize retention, resource allocation, or some custom optimization function which takes into account a number of different objectives.

The present disclosure provides a number of technical effects and benefits. As one example of technical effect and benefit, in some implementations, the systems and methods of the present disclosure can select content items for various time slots in a reward impression to improve retention or allocation of resources. Thus, reward impressions can be performed with improved accuracy and efficacy because the content items are selected and optimized for various time slots in the reward impressions. This improved efficacy can result in fewer reward impressions overall, as a single impression will have a plurality of content items. In conventional systems, a reward impression was required for presenting each content item. In contrast, the present invention enables the system to present multiple content items in one reward impression. For example, the system can automatically truncate one of the content items in order to fit the plurality of content items in the allocated amount of time for the reward impression. The use of fewer reward impressions overall can save computing resources such as processor usage, memory usage, and/or network bandwidth usage, as fewer impression actions-which require use of computing resources—are required to be performed overall.

With reference now to the Figures, example embodiments of the present disclosure will be discussed in further detail.

### Example Devices and Systems

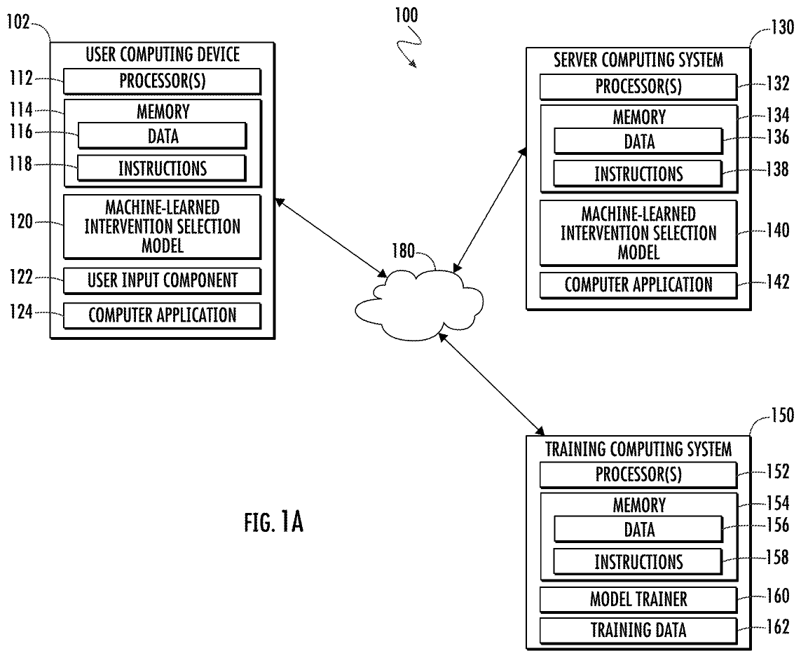

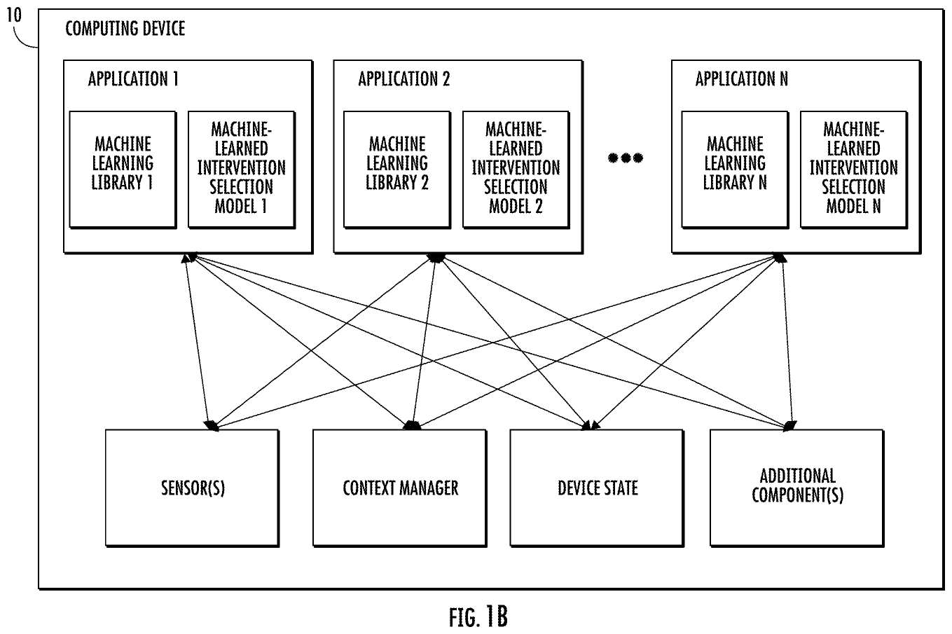

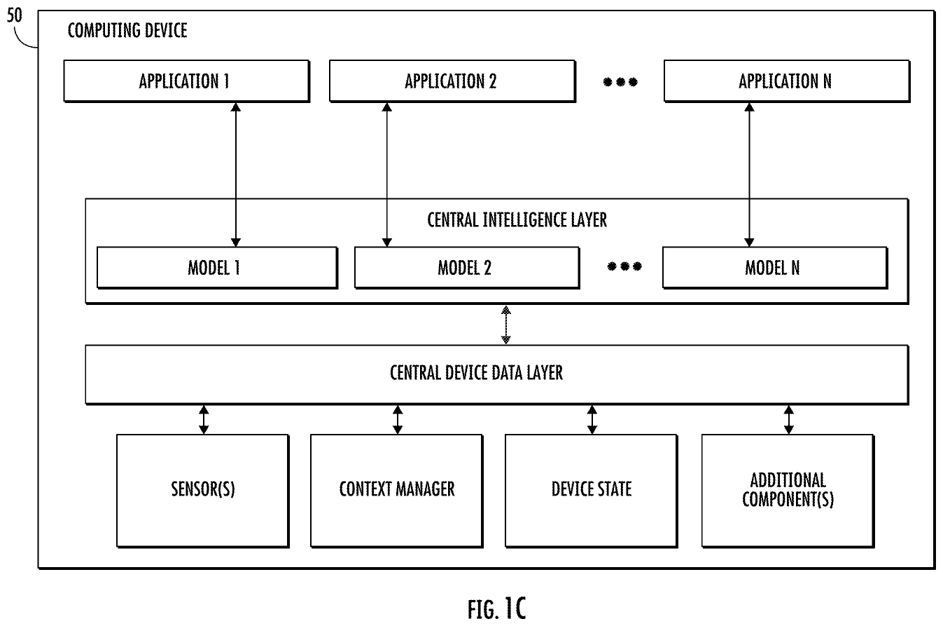

FIG. 1A depicts a block diagram of an example computing system 100 that performs content item selection for various time slots according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

The user computing device 102 can store or include one or more machine-learned models 120. For example, the machine-learned models 120 can be or can otherwise include various machine-learned models such as neural networks (e.g., deep neural networks) or other multi-layer non-linear models. Neural networks can include recurrent neural networks (e.g., long short-term memory recurrent neural networks), feed-forward neural networks, or other forms of neural networks. The machine-learned models 120 can include other types of models as well such as, for example, decision tree-based models (e.g., random forests), support vector machines, various types of classifier models, linear models, and/or other types of models.

In some implementations, the one or more machine-learned models 120 can be received from the server computing system 130 over network 180, stored in the user computing device memory 114, and the used or otherwise implemented by the one or more processors 112. In some implementations, the user computing device 102 can implement multiple parallel instances of a single machine-learned model 120 (e.g., to perform parallel impression optimization across multiple instances of impression optimization).

More particularly, the machine-learned model can provide a respective probability that each of the plurality of available content item being presented at various time slots of the reward impression will improve a total conversion rate (e.g., summation of the respective conversion rate for each content item being presented at a specific time slot). Thus, the machine-learned model can compute a respective conversion rate that each of the plurality of available content items being presented at various time slots (e.g. a first time slot, a second time slot) will improve the total conversion rate.

In other implementations, instead of minimizing the probability of user churn, the system can choose and present a content item according to an expression that measures the probability that each content item will increase an objective value (e.g., specific content type as requested by developer).

In some implementations, the machine-learned model can be trained and operated according to a reinforcement learning scheme. For example, the machine-learned model can be or include an impression agent in a reinforcement learning scheme. For example, the impression agent can apply a policy to select certain actions (e.g., presentation of a content item at a specific time slot) based on a current state and can receive a conversion rate associated with an outcome of each action. The computing system can optimize the machine-learned model based on the respective conversion rate to improve the policy (e.g., maximize the total conversion rate) of the impression agent. For example, the model can optimize so that the summation of the respective conversion rate associated with each content item being presented in the various time slots is maximized.

In some implementations, in addition or alternatively to the use of reinforcement learning, the machine-learned model can be trained using supervised learning techniques, as further described in training computing system 150.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an impression optimization service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can enter a communication.

The user computing device 102 can also include a computer application 124. The computer application 124 can include various different computer programs, software, and/or systems. One example application is a mobile application such as, for example, a text messaging application installed on a mobile device (e.g., smartphone). Another example of a computer application is a computer game (e.g., a mobile game, a game for a dedicated gaming console, a massively multiplayer online game, a browser game, a game embedded in a social media platform, an augmented or virtual reality game, etc.). Another example application may be a traditional computer application executed on a desktop, laptop, tablet, or the like.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise includes one or more machine-learned models 140. For example, the machine-learned models 140 can be or can otherwise include various machine-learned models such as neural networks (e.g., deep recurrent neural networks) or other multi-layer non-linear models. The machine-learned models 140 can include other types of models as well such as, for example, decision tree-based models (e.g., random forests), support vector machines, various types of classifier models, linear models, and/or other types of models.

The server computing system 130 can also include a computer application 142. The computer application 142 can include various different computer programs, software, and/or systems. One example application is a mobile application such as, for example, a text messaging application installed on a mobile device (e.g., smartphone). Another example of a computer application is a computer game (e.g., a mobile game, a game for a dedicated gaming console, a massively multiplayer online game, a browser game, a game embedded in a social media platform, an augmented or virtual reality game, etc.). Another example application may be a traditional computer application executed on a desktop, laptop, tablet, or the like.

The server computing system 130 can train the machine-learned models 120 or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 140 stored at the server computing system 130 using various training or learning techniques, such as, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train a machine-learned model 140 based on a set of training data 162. The training data 162 can include, for example, a set of conversion rates for different content items and reward impressions. The training data can include a respective ground-truth label for each pair of conversion rate/impression that describes a known outcome that occurred after the impression. The training data 162 can also include rewards determined for certain actions.

In some implementations, if the user has provided consent, the training examples can be provided by the user computing device 102 (e.g., based on communications previously provided by the user of the user computing device 102). Thus, in such implementations, the model 120 provided to the user computing device 102 can be trained by the training computing system 150 on user-specific communication data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the machine-learned models 120 can be both trained and used locally at the user computing device 102. In some of such implementations, the user computing device 102 can implement the model trainer 160 to personalize the machine-learned models 120 based on user-specific data.

FIG. 1B depicts a block diagram of an example computing device 10 that performs impression optimization according to example embodiments of the present disclosure. The computing device 10 can be a user computing device or a server computing device.

The computing device 10 includes a number of applications (e.g., applications 1 through N). Each application contains its own machine learning library and machine-learned model(s). Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs impression optimization according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single machine-learned model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Methods

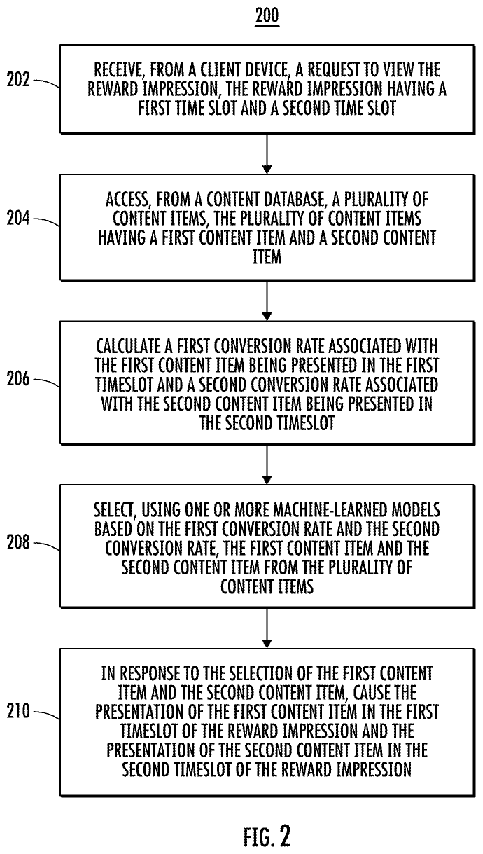

FIG. 2 depicts a flow chart diagram of an example method to present a reward impression in a computer application according to example embodiments of the present disclosure. Although FIG. 2 depicts steps performed in a particular order for purposes of illustration and discussion, the methods of the present disclosure are not limited to the particularly illustrated order or arrangement. The various steps of method 200 can be omitted, rearranged, combined, and/or adapted in various ways without deviating from the scope of the present disclosure.

In some instances, a computing system can present a reward impression in a computer application (e.g., computer application 124, computer application 142). The computing system can include one or more processors, and one or more non-transitory computer-readable media that collectively store: one or more machine-learned models configured to determine a time slot to present a content item in the reward impression; and instructions that, when executed by the one or more processors, cause the computing system to perform operations described in method 200.

At 202, a computing system can receive, from a client device (e.g., user computer device 102), a request to view the reward impression. In some instances, the reward impression can have a plurality of time slots (e.g., a first time slot, a second time slot). For example, the computing system can be the server computing system 130 depicted in FIG. 1A.

At 204, the computing system can access, from a content database, a plurality of content items. In some instances, the plurality of content items can have a first content item, a second content item, a third content item, and so on. For example, the content database can be stored in memory 134 of the server computing system 130 depicted in FIG. 1A.

At 206, the computing system can calculate (e.g., predict) a first conversion rate associated with the first content item being presented in the first time slot. In some instances, the computing system predicts the first conversion rate associated with the first content item being presented in the first time slot. Additionally, the computing system can calculate a second conversion rate associated with the second content item being presented in the second time slot.

The system includes one or more machine-learned models to predict user engagement during presentation of the third-party media and calculate a predicted conversion rate (e.g., a likelihood that the user engaged with the presented media). The models can include a prediction mechanism that predicts a predicted conversion value (e.g., clickthrough rate (CTR)) for any format or any creative. The model can determine the first content item and the second content item based on the predicted conversion rate for presenting each content item in the different time slots, and a bid value for a conversion of each content item in the different time slots. For example, the model can optimize (e.g., maximize) based on the based on the predicted conversion rate for presenting each content item in the different time slots, and a bid value for a conversion of each content item in the different time slots.

In some instances, the computing system can calculate, using the one or more machine-learned models (e.g., machine-learned model 120, machine-learned model 140), the first conversion rate associated with the first content item being presented in a first time slot of the reward interaction. Additionally, the computing system can calculate a subsequent conversion rate associated with the first content item being presented in a second time slot of the reward interaction.

In some instances, the computing system can update the content database by associating the first content item with the first conversion rate and the subsequent conversion rate. For example, the subsequent conversion rate can be less than the first conversion rate because the first time slot can have a higher value (e.g., higher likelihood of a conversion).

In some instances, the first conversion rate can be calculated by the one or more machine-learned model based on a cost per impression rate for presenting the first content item in the first time slot of the reward impression.

In some instances, the first conversion rate can be calculated by the one or more machine-learned model based on a preference from a publisher, the preference being associated with a type of content being presented in the first time slot of the reward impression.

At 208, the computing system can select, using the one or more machine-learned models based on the first conversion rate and the second conversion rate, the first content item to be presented in the first time slot and the second content item to be presented in the second time slot. In some instances, the computing system can select, using the one or more machine-learned models further based on a first bid value associated with the first content item to be presented in the first time slot and a second bid value associated with the second content item to be presented in the second time slot. For example, the computing system can select, using the models, the first content item to be presented in the first time slot based on the first conversion rate and the first bid value. The first bid value can be received from a device associated with the first content item, such as the game developer that develop the first content item. Additionally, the computing system can select, using the models, the second content item to be presented in the second time slot based on the second conversion rate. Moreover, the second content item can be further selected based on the selection of the first content item. For example, when the first content item is a first content type (e.g., mobile application to download), then based on the type of content requested by the developer, then the second content item can be a second content type (e.g., link to a website). By having different content types being presented in the different time slots, the reward impression can have a diversity of content items.

At 210, the computing system in response to the selection of the first content item and the second content item, can cause the presentation of the first content item in the first time slot of the reward impression and the presentation of the second content item in the second time slot of the reward impression. For example, the reward impression can be presented on a display of user computing device 102 depicted in FIG. 1A. The reward impression can be presented directly in the computer application 124 of the user computing device 102.

In some instances, the computing system can receive, from a third-party application, the first content item.

In some instances, the first content item can have a first duration and the second content item can have a second duration. The computing system can select, based on the first duration, the first content item from the plurality of content items to be presented in the first time slot of the reward impression. Additionally, the computing system can select, based on the second duration, the second content item from the plurality of content items to be presented in the second time slot of the reward impression.

In some instances, the computing system can calculate a total duration value by adding the first duration and the second duration; determining that a total duration value is greater than a threshold time value associated with the reward impression. Additionally, in response to the total duration value being greater than the threshold time value, the computing system can modify the first content item, using the one or more machine-learned model, by removing a section of the first content item.

In some instances, the first content item can include a first video and a first end card. The first end card can be presented after the first video with a link to install a first mobile application on the client device. Additionally, the second content item can include a second video and a second end card. Moreover, the second end card can be presented in response to a swipe gesture to the first end card.

In some instances, the second content item is further determined based on the first content item.

In some instances, the first content item is presented on a mobile application that is developed by a developer.

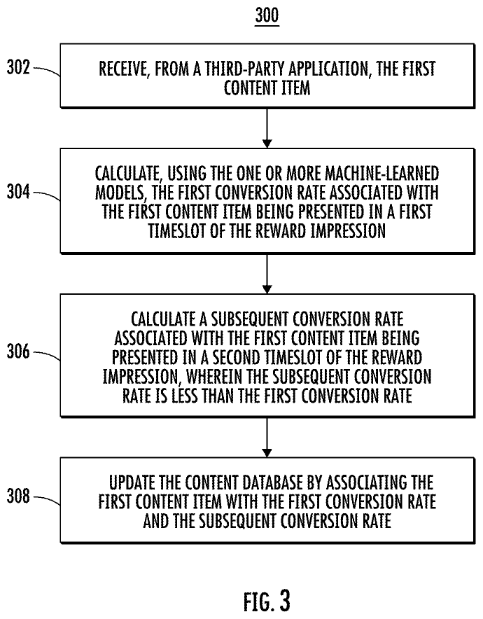

FIG. 3 depicts a flow chart diagram of an example method to calculate conversion rates for a content item to be presented in different time slots of a reward impression according to example embodiments of the present disclosure. Although FIG. 3 depicts steps performed in a particular order for purposes of illustration and discussion, the methods of the present disclosure are not limited to the particularly illustrated order or arrangement. The various steps of method 300 can be omitted, rearranged, combined, and/or adapted in various ways without deviating from the scope of the present disclosure.

At 302, the computing system can receive, from a third-party application, the first content item.

At 304, the computing system can calculate, using the one or more machine-learned models (e.g., machine-learned model 120, machine-learned model 140), the first conversion rate associated with the first content item being presented in a first time slot of the reward impression.

In some instances, the first conversion rate can be calculated by the one or more machine-learned model based on a cost per impression rate for presenting the first content item in the first time slot of the reward impression.

In some instances, the first conversion rate can be calculated by the one or more machine-learned model based on a type of content being presented in the first time slot of the reward impression. For example, the type of content being received by a developer of the computer application.

At 306, the computing system can calculate, using the models (e.g., machine-learned model 120, machine-learned model 140) a subsequent conversion rate (e.g., a second conversion rate) associated with the first content item being presented in a second time slot of the reward impression. In some instances, the subsequent conversion rate can be less than the first conversion rate because the first time slot can have a higher likelihood of conversion.

In some instances, the subsequent conversion rate can be calculated by the one or more machine-learned model based on a cost per impression rate for presenting the second content item in the second time slot of the reward impression.

In some instances, the subsequent conversion rate is calculated by the one or more machine-learned model based on a type of content being presented in the second time slot of the reward impression. For example, the type of content can be received by a developer of the computer application.

At 308, the computing system can update the content database by associating the first content item with the first conversion rate and the subsequent conversion rate. For example, the content database can be part of the memory 134 of the server computing system 130 depicted in FIG. 1A. The computing system can store the conversion rates in the memory 134 so that the conversion rates can be retrieved at a later time during future selections of content items to be presented in reward impressions.

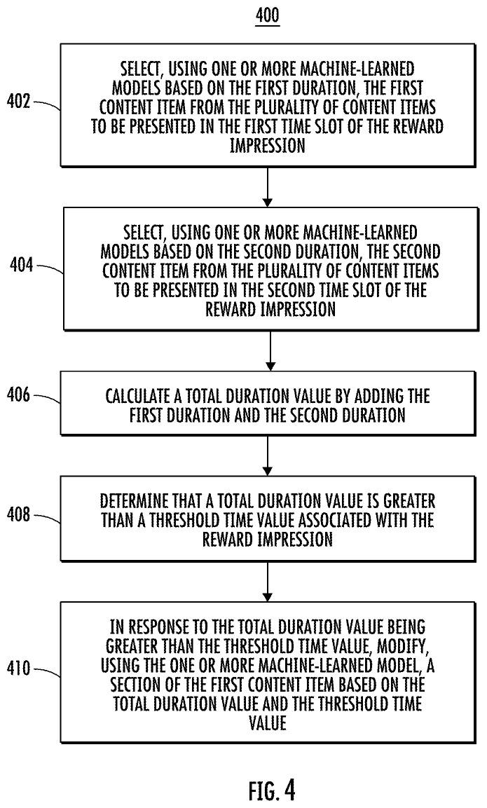

FIG. 4 depicts a flow chart diagram of an example method to truncate a content item prior to presenting the content item in a time slot of a reward impression according to example embodiments of the present disclosure. Although FIG. 4 depicts steps performed in a particular order for purposes of illustration and discussion, the methods of the present disclosure are not limited to the particularly illustrated order or arrangement. The various steps of method 400 can be omitted, rearranged, combined, and/or adapted in various ways without deviating from the scope of the present disclosure.

In some instances, the first content item can have a first duration, and the second content item can have a second duration.

At 402, the computing system can select, using the one or more machine-learned models (e.g., machine-learned model 120, machine-learned model 140) based on the first duration, the first content item from the plurality of content items to be presented in the first time slot of the reward impression.

At 404, the computing system can select, using the one or more machine-learned models based on the second duration, the second content item from the plurality of content items to be presented in the second time slot of the reward impression.

At 406, the computing system can calculate a total duration value by adding the first duration and the second duration.

At 408, the computing system can determine that a total duration value is greater than a threshold time value associated with the reward impression. The threshold time value can be the maximum amount of time for the reward impression. For example, a reward impression may have a predetermined (e.g., 30 seconds) time limit.

At 410, in response to the total duration value being greater than the threshold time value, the computing system can modify, using the one or more machine-learned model, a section of the first content item based on the total duration value and the threshold time value.

In some instances, the second content item can be a video. Additionally, the computing system can remove, using the one or more machine-learned model, a portion of the video based on the modification of the first content item, the total duration value, and the threshold time value. For example, the model can determine less relevant portions of the video and remove the less relevant portions in order to reduce the duration of the video so that the combined duration of both the first content item and the second content item are equal to or below the threshold time value associated with the reward impression.

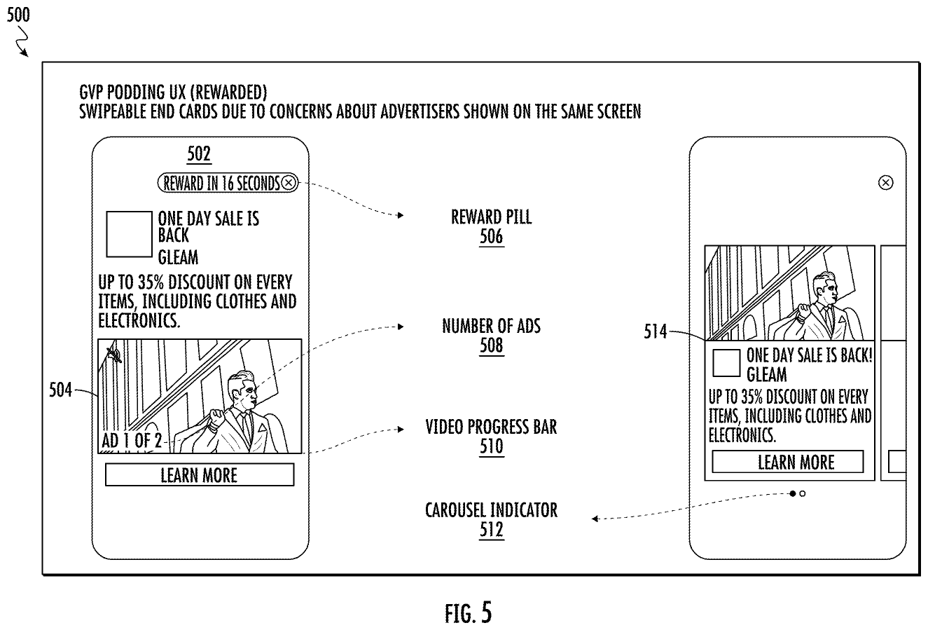

FIG. 5 depicts a block diagram of an example graphical user interface 500 of a reward impression being presented on a client device according to example embodiments of the present disclosure. As shown in FIG. 5, the graphical user interface 500 can include a reward impression 502. The reward impression 502 can include a first content item 504. Additionally, a reward pill 506 can be given to a user after the user has viewed the reward impression 502. Moreover, the reward impression 502 can include a number of content items 508. Furthermore, the reward impression 502 can include a progress bar 510. Once the content items have been viewed, the reward impression 502 can include end cards 514 with a carousel indicator 512. A user can swipe the different end cards, as indicated by the carousel indicator 512.

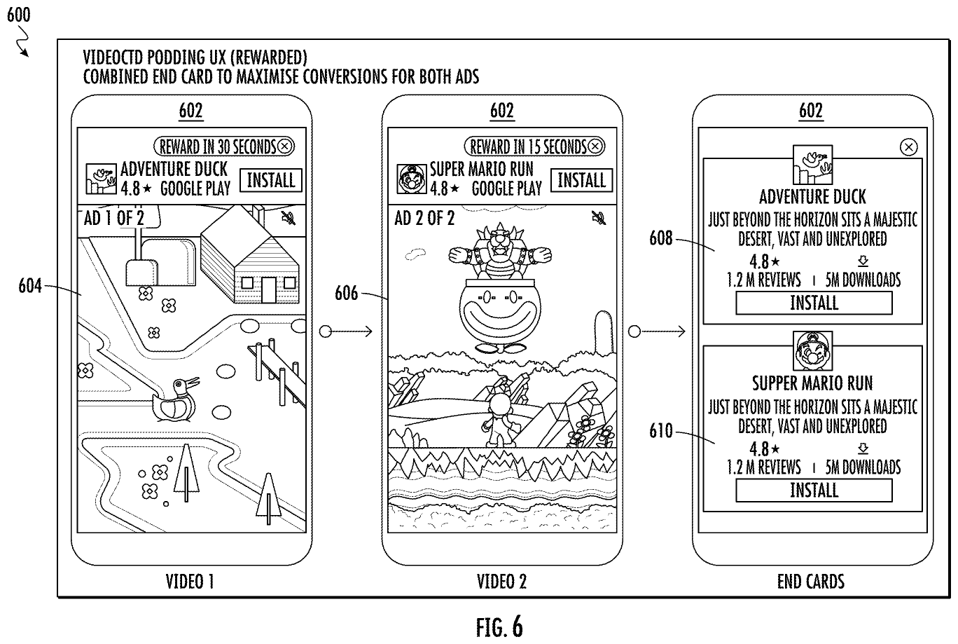

FIG. 6 depicts a block diagram of another example graphical user interface 600 of a reward impression 602 being presented on a client device according to example embodiments of the present disclosure. As shown in FIG. 6, the reward impression 602 can have a first content item 604, and a second content item 606. Additionally, the reward impression can have a first end card 608 associated with the first content item 604. Moreover, the reward impression 602 can have a second end card 610 associated with the second content item 606. For example, the first end card 608 can enable a user to download a first mobile game associated with the first content item 604. The second end card 610 can enable a user to download a second mobile game associated with the second content item 606.

### Additional Disclosure

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computing system to present a reward impression in a computer application, comprising:
one or more processors; and
one or more non-transitory computer-readable media that collectively store:
one or more machine-learned models configured to determine a time slot to present a content item in the reward impression; and
instructions that, when executed by the one or more processors, cause the computing system to perform operations, the operations comprising:
receiving, from a client device, a request to view the reward impression, the reward impression having a first time slot and a second time slot;
accessing, from a content database, a plurality of content items, the plurality of content items having a first content item and a second content item;
calculating a first conversion rate associated with the first content item being presented in the first time slot and a second conversion rate associated with the second content item being presented in the second time slot;
selecting, using the one or more machine-learned models based on the first conversion rate and the second conversion rate, the first content item to be presented in the first time slot and the second content item to be presented in the second time slot; and
in response to the selection, causing the presentation of the first content item in the first time slot of the reward impression and the presentation of the second content item in the second time slot of the reward impression.

2. The computing system of claim 1, the operations further comprising:
receiving, from a third-party application, the first content item;
calculating, using the one or more machine-learned models, the first conversion rate associated with the first content item being presented in a first time slot of the reward impression; and
calculating a subsequent conversion rate associated with the first content item being presented in a second time slot of the reward impression.

3. The computing system of claim 2, the operations further comprising:
updating the content database by associating the first content item with the first conversion rate and the subsequent conversion rate.

4. The computing system of claim 2, wherein the subsequent conversion rate is less than the first conversion rate.

5. The computing system of claim 1, wherein the first conversion rate is calculated by the one or more machine-learned models based on a cost per impression rate for presenting the first content item in the first time slot of the reward impression.

6. The computing system of claim 1, wherein the second conversion rate is calculated by the one or more machine-learned models based on a cost per impression rate for presenting the second content item in the second time slot of the reward impression.

7. The computing system of claim 1, wherein the first conversion rate is calculated by the one or more machine-learned models based on a type of content being presented in the first time slot of the reward impression, the type of content being received by a developer of the computer application.

8. The computing system of claim 1, wherein the first content item has a first duration and the second content item has a second duration, the operations further comprising:
selecting, using the one or more machine-learned models based on the first duration, the first content item from the plurality of content items to be presented in the first time slot of the reward impression; and
selecting, using the one or more machine-learned models based on the second duration, the second content item from the plurality of content items to be presented in the second time slot of the reward impression.

9. The computing system of claim 8, the operations further comprising:
calculating a total duration value by adding the first duration and the second duration;
determining that the total duration value is greater than a threshold time value associated with the reward impression; and
in response to the total duration value being greater than the threshold time value, modifying, using the one or more machine-learned models, a section of the first content item based on the total duration value and the threshold time value.

10. The computing system of claim 9, wherein the second content item is a video, the operations further comprising:
removing, using the one or more machine-learned models, a portion of the video based on the modification of the first content item, the total duration value, and the threshold time value.

11. The computing system of claim 1, wherein the first content item includes a first video and a first end card, wherein the first end card is presented after the first video with a link to install a first mobile application on the client device.

12. The computing system of claim 11, the second content item includes a second video and a second end card, wherein the second end card is presented in response to a swipe gesture to the first end card.

13. The computing system of claim 1, wherein the second content item is further selected to be presented in the second time slot based on the first content being selected to be presented in the first time slot.

14. The computing system of claim 1, wherein the first content item is presented on the computer application, the mobile application being developed by a developer.

15. The computing system of claim 1, wherein the reward impression includes a video progress bar.

16. The computing system of claim 1, wherein the reward impression includes an indication associated with a number of content items to be presented in the reward impression.

17. A computer-implemented method to present a reward impression in a computer application, the method comprising:
receiving, from a client device, a request to view the reward impression, the reward impression having a first time slot and a second time slot;
accessing, from a content database, a plurality of content items, the plurality of content items having a first content item and a second content item;
calculating a first conversion rate associated with the first content item being presented in the first time slot and a second conversion rate associated with the second content item being presented in the second time slot;
selecting, using one or more machine-learned models based on the first conversion rate and the second conversion rate, the first content item to be presented in the first time slot and the second content item to be presented in the second time slot; and
in response to the selection, causing the presentation of the first content item in the first time slot of the reward impression and the presentation of the second content item in the second time slot of the reward impression.

18. The method of claim 17, further comprising:
receiving, from a third-party application, the first content item;
calculating, using the one or more machine-learned models, the first conversion rate associated with the first content item being presented in a first time slot of the reward impression;
calculating a subsequent conversion rate associated with the first content item being presented in a second time slot of the reward impression, wherein the subsequent conversion rate is less than the first conversion rate; and
updating the content database by associating the first content item with the first conversion rate and the subsequent conversion rate.

19. The method of claim 17, wherein the first content item has a first duration, and the second content item has a second duration, the method further comprising:
selecting, using the one or more machine-learned models based on the first duration, the first content item from the plurality of content items to be presented in the first time slot of the reward impression;
selecting, using the one or more machine-learned models based on the second duration, the second content item from the plurality of content items to be presented in the second time slot of the reward impression;
calculating a total duration value by adding the first duration and the second duration;
determining that the total duration value is greater than a threshold time value associated with the reward impression; and
in response to the total duration value being greater than the threshold time value, modifying, using the one or more machine-learned model, a section of the first content item based on the total duration value and the threshold time value.

20. A computer-readable media that store instructions that, when executed by one or more computing devices, cause the one or more computing devices to perform operations, the operations comprising:
receiving, from a client device, a request to view a reward impression, the reward impression having a first time slot and a second time slot;
accessing, from a content database, a plurality of content items, the plurality of content items having a first content item and a second content item;
calculating a first conversion rate associated with the first content item being presented in the first time slot and a second conversion rate associated with the second content item being presented in the second time slot;
selecting, using one or more machine-learned models based on the first conversion rate and the second conversion rate, the first content item and the second content item from the plurality of content items; and
in response to the selection of the first content item and the second content item, causing the presentation of the first content item in the first time slot of the reward impression and the presentation of the second content item in the second time slot of the reward impression.
